(19) United States
(12) Patent Application Publication
(10) Pub. No.: US 2010/0321918 A1
(43) Pub. Date: Dec. 23, 2010

(54) Clip-on Lampshade Adaptor for Enhanced Gripping of both Standard Incandescent and Compact Fluorescent Light Bulbs

(76) Inventor: John R. D'Alelio, Braintree, MA (US)

Correspondence Address: Russ Weinzimmer, 614 Nashua Street, Suite 53, Milford, NH, 03055, US

(21) Appl. No.: 12/490,289

(22) Filed: Jun. 23, 2009

(51) Int. Cl. F21V 9/16; F21V 21/08; H01J 9/24

(52) U.S. Cl. 362/84; 362/396; 445/23

(57) ABSTRACT

A retro-fit light-bulb clip adaptor kit and method of use thereof are disclosed that increase the frictional gripping strength of a conventional light-bulb clip, thereby allowing a clip-on lampshade or a clip-on lampshade adaptor to be more securely attached to either a traditional light bulb or a compact fluorescent “CFL” light bulb. The kit includes at least one length of longitudinally split tubing made from a heat-resistant, elastic material. The tubing is split open and applied to the bulb-gripping wires so as to completely cover the gripping loops, and thereby provide a surface with enhanced static friction. The elastic material thereafter provides increased static friction so as to enhance the loop's ability to grip either a standard bulb or a CFL bulb. The tubing is preferably made from either PVC, latex, silicone, heat resistant rubber, a heat resistant engineering polymer, polyalkylene-terephthalate, isophthalate, or copolyesters, but most preferably silicone.

### FIELD OF THE INVENTION

The invention generally relates to lampshades, and more specifically to clip-on lampshades.

### BACKGROUND OF THE INVENTION

One popular mechanism for attaching a lampshade to a lamp is to use a light-bulb clip that clips directly to the light bulb of the lamp. Typically, a light-bulb clip made from a pair of heavy wire loops that are permanently attached to the lampshade and are able to extend around a light bulb on opposing sides and press toward each other, trapping the light bulb in-between. This approach is used to support lampshades with a variety of weights and sizes, as well as lampshades that include decorative materials such as glass or ceramic, and/or decorative shaping such as pleated cloth. However, for many large and/or heavy lampshades, if the light-bulb clip does not grip the light bulb with sufficient friction, the size and/or weight of the lampshade can cause it to tip out of alignment, for example when the lampshade is subject to external forces, such as being accidentally bumped by a person passing by.

Most large and heavy lampshades are so-called “finial” lampshades, in that they do not attach to a light bulb, but are supported instead by a separate harp-frame structure that is directly attached to the body of the lamp. Sometimes, it is desirable to use a so-called “finial” lampshade with a lamp that is intended for use with a clip-on lampshade. In such cases, the finial lampshade can be adapted for clip-on use by a so-called finial clip-on lampshade adaptor, which includes a light-bulb clip at one end, and a finial attachment mount at the other end. However, if the finial lampshade is too large and/or too heavy, lack of sufficient frictional gripping strength of the light-bulb clip of the finial clip-on lampshade adaptor can prevent the successful adaptation of the finial lampshade for clip-on use. For example, the finial clip-on lampshade adaptor can tip over, and possibly even slip off the bulb.

So as to improve the energy efficiency of lamps, and thereby reduce cost and minimize impact on the environment, it is often desirable to replace conventional incandescent light bulbs in lamps with so-called compact fluorescent light (CFL) bulbs that are approximately the same size as conventional incandescent light bulbs and can be directly substituted for conventional incandescent bulbs, but which last significantly longer than conventional incandescent bulbs while consuming less energy. However, while the general size of a replacement fluorescent light bulb is usually similar to a conventional incandescent bulb, the shape of a replacement fluorescent bulb is typically quite different from the shape of a conventional incandescent bulb.

A conventional light bulb typically is rounded and pear-shaped, while the most common CFL bulbs typically consist of long, gas-filled tubes that have been coiled into a spiral shape. For this reason, a light-bulb-clip that is configured for firm attachment to a conventional light bulb, will often not attach to a replacement fluorescent light bulb with sufficient static friction to maintain the lampshade in position. As a consequence, the lampshade can tip and/or fall off, possibly even damaging the lampshade and/or the lamp.

One possible way to ensure adequate frictional gripping strength of a lampshade adapter is to restrict its use to a replacement fluorescent light bulb with a surrounding, transparent, pear-shaped shell. While such light bulbs are currently available to consumers, they are significantly more expensive than the far more common coiled spiral CFL's. Furthermore, recent tests have shown that the current CFL's with pear-shaped shells over their coils can take up to fives times longer to reach maximum brightness, as compared to common coiled spiral CFL's of the same wattage. Therefore, CFL's with pear-shaped shells potentially offer less convenience to the user.

### SUMMARY OF THE INVENTION

A retro-fit light-bulb clip adaptor and a method of using the adaptor are claimed herein. The retro-fit light-bulb clip adaptor increases the frictional gripping strength of a conventional light-bulb clip, thereby allowing a clip-on lampshade or a finial clip-on lampshade adaptor to be attached more securely to a traditional pear-shaped incandescent bulb. The retro-fit light-bulb clip adaptor even enables most clip-on lampshades, and finial lampshades with finial clip-on lampshade adaptors, to be firmly attached to a coiled, spiral-shaped CFL bulb, with sufficient friction to hold the lampshade firmly in place.

The retro-fit light-bulb clip adaptor includes lengths of longitudinally split tubing which are made from an elastic material. The split tubing is able to mate with and cover the wire loops of a conventional light-bulb clip, and the elastic material provides increased friction when pressed against either a standard incandescent bulb, or a replacement fluorescent “CFL” bulb.

In some preferred embodiments, the split tubing is made from a heat-resistant elastomeric material such as PVC, latex, silicone, heat-resistant rubber (and its derivative materials), heat-resistant engineering polymers, polyalkylene-terephthalate, isophthalate, and/or copolyesters. Of these various elastomers, silicone appears to offer the best option because of its thermal stability over a wide temperature range. In some preferred embodiments, the elastomeric material includes a “glow-in-the-dark” phosphorescent ingredient which can absorb ambient light, and then emit a glowing light when ambient light is not present, thereby making it easier for a user to locate the lamp in the dark.

### BRIEF DESCRIPTION OF THE DRAWINGS

The invention will be more fully understood by reference to the detailed description, in conjunction with the following figures, wherein:

FIG. 1 is a perspective drawing that illustrates a conventional clip-on lampshade of the prior art that is supportable by attachment of a wire-loop light-bulb clip to a conventional light bulb;

FIG. 2A is a perspective drawing that illustrates a “finial” clip-on lampshade adaptor of the prior art that can be used to convert lampshades into clip-on lampshades;

FIG. 2B is a perspective drawing that illustrates an exploded view of the finial clip-on lampshade adaptor of FIG. 2A;

FIG. 3A is a perspective drawing that illustrates a typical contour of a standard incandescent light bulb;

FIG. 3B is a perspective drawing that illustrates a typical contour of a commonly used compact fluorescent light (CFL) bulb;

FIG. 4 is a close-up view of the light-bulb clip of FIG. 2 with an embodiment of the present invention installed thereupon;

FIG. 5A is a close-up view of the embodiment shown in FIG. 4 being clipped to the standard incandescent light bulb shown in FIG. 3A;

FIG. 5B is a close-up view of the embodiment shown in FIG. 4 being clipped to the CFL bulb shown in FIG. 3B;

FIG. 6A is a perspective drawing that illustrates an initial step of the method of the present invention in a preferred embodiment;

FIG. 6B is a perspective drawing that illustrates the step of splitting open the longitudinally split tubing in the embodiment shown in FIG. 6A;

FIG. 6C is a perspective drawing that illustrates the method shown in FIG. 6A at a step where installation of the longitudinally split tubing on one of the wire loops of the lampshade clip is nearly complete;

FIG. 7A is a perspective drawing that illustrates a phosphorescent ingredient in a preferred embodiment absorbing light from an active light bulb; and

FIG. 7B is a perspective drawing that illustrates the phosphorescent ingredient emitting light when the light bulb is inactive.

### DETAILED DESCRIPTION OF PREFERRED EMBODIMENTS

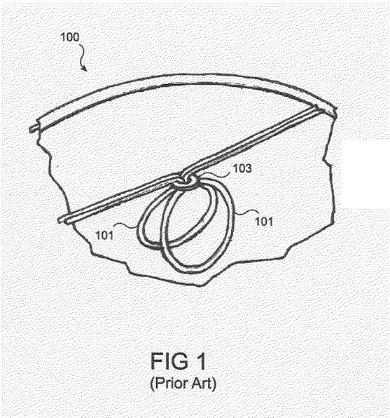

With reference to FIG. 1, a typical clip-on lampshade 100 includes a pair of wire loops 101 made of metal, which extend around each side of a light bulb and press toward each other, trapping the light bulb in between and frictionally gripping the light bulb 103. The frictional gripping strength of the light-bulb clip formed by the wire loops 101 is directly dependent on the area of contact between the wire loops and the light bulb. The rounded, pear-like shape of a conventional incandescent light bulb provides for continuous contact with the wire loops over nearly the entire lengths of the wire loops.

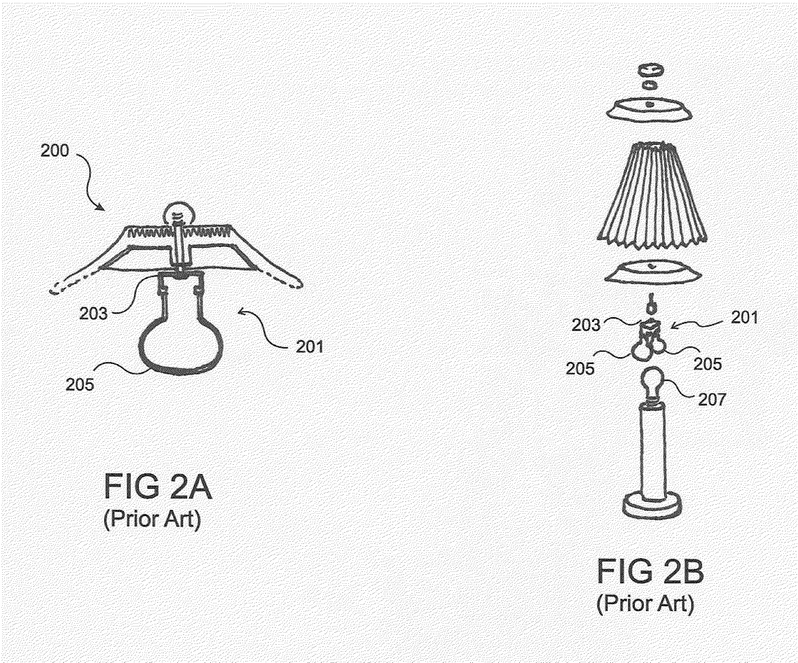

FIG. 2A illustrates a finial lampshade 200 that is designed to be attached to a lamp by a harp-frame (not shown) that is directly attached to the lamp body. However, in FIG. 2A a finial clip-on lampshade adaptor 201 has been used to adapt the finial lampshade 200 for clip-on attachment to a light bulb 207. The finial clip-on lampshade adaptor 201 includes a finial attachment at one end 203, and a light-bulb clip 205 at the other end. This approach allows a lampshade that was not originally designed for clip-on use to be used with a lamp that is intended for use with a clip-on lampshade. However, if the finial clip-on lampshade adaptor 201 does not provide sufficient gripping strength, adaptation of the finial lampshade for clip-on use will not succeed in firmly securing the lampshade to the light bulb. FIG. 2B is an exploded view of the lampshade 200 and the finial clip-on lampshade adaptor 201 of FIG. 2A.

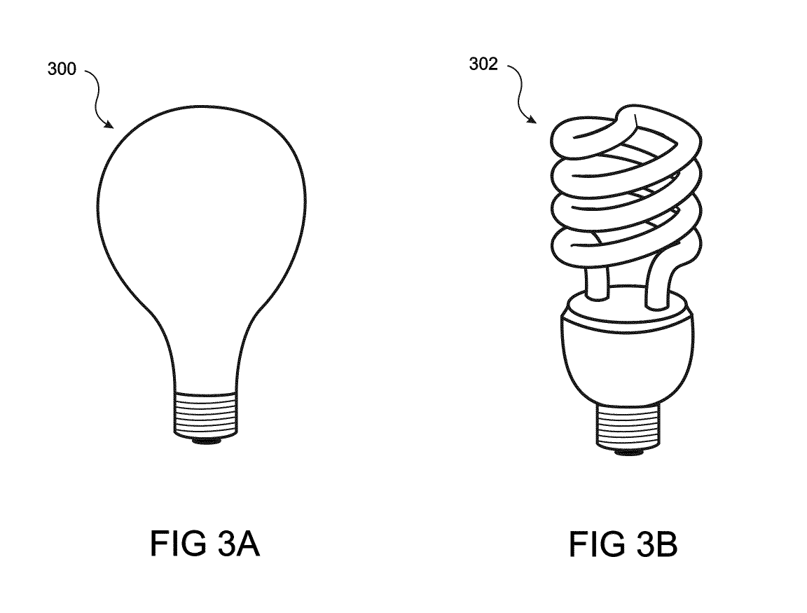

The light bulb clips shown in FIG. 1, FIG. 2A and FIG. 2B provide sufficient friction gripping strength to securely support many lampshades when attached to a conventional, pear-shaped incandescent light bulb 300, such as the bulb illustrated in FIG. 3A. However, due to ecological and/or economic concerns, it is often desirable to replace a conventional incandescent light bulb 300 with an energy efficient, compact, fluorescent light (CFL) bulb 302 such as the bulb shown in FIG. 3B. Although approximately the same size as a conventional incandescent light bulb 300, a CFL bulb 302 has a markedly different shape than a conventional incandescent light bulb. Typically, a CFL bulb 302 is a long, gas-filled tube coiled into a spiral shape. When a conventional light-bulb clip is attached to a CFL bulb 302, only a fraction of the light-bulb clip's wire loops makes contact with the CFL bulb 302, thereby significantly reducing the frictional gripping strength of the light bulb clip, potentially causing the lampshade to fall out of position, even possibly causing the lampshade to fall off of the bulb, and/or causing the lamp to fall over.

While it is possible to use a compact fluorescent light (CFL) bulb with a surrounding, translucent, pear-shaped shell to make the CFL bulb compatible with clip-on lampshades, such light bulbs are significantly more expensive than coiled spiral CFL bulbs. Furthermore, tests have shown that these bulbs with pear-shaped shells take much longer to reach maximum brightness than regular CFL bulbs of equivalent wattage, and so they tend to be much less convenient for users.

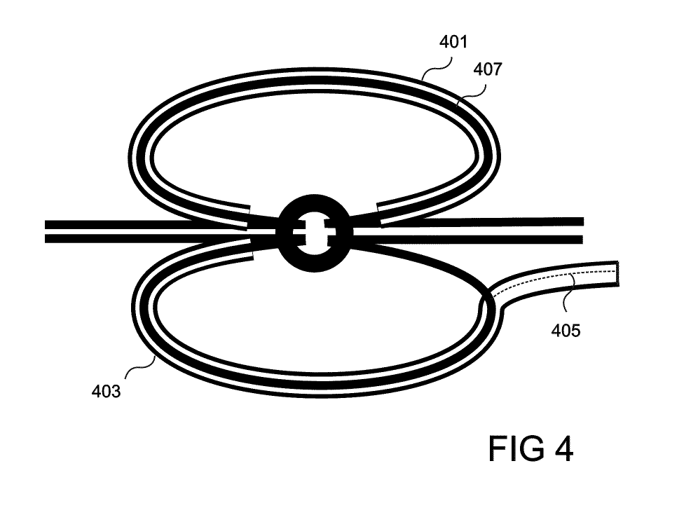

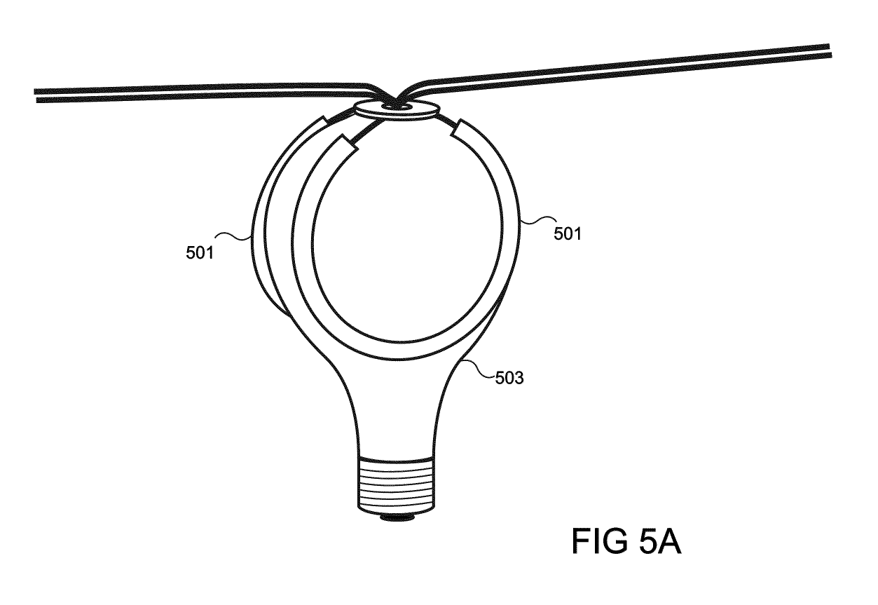

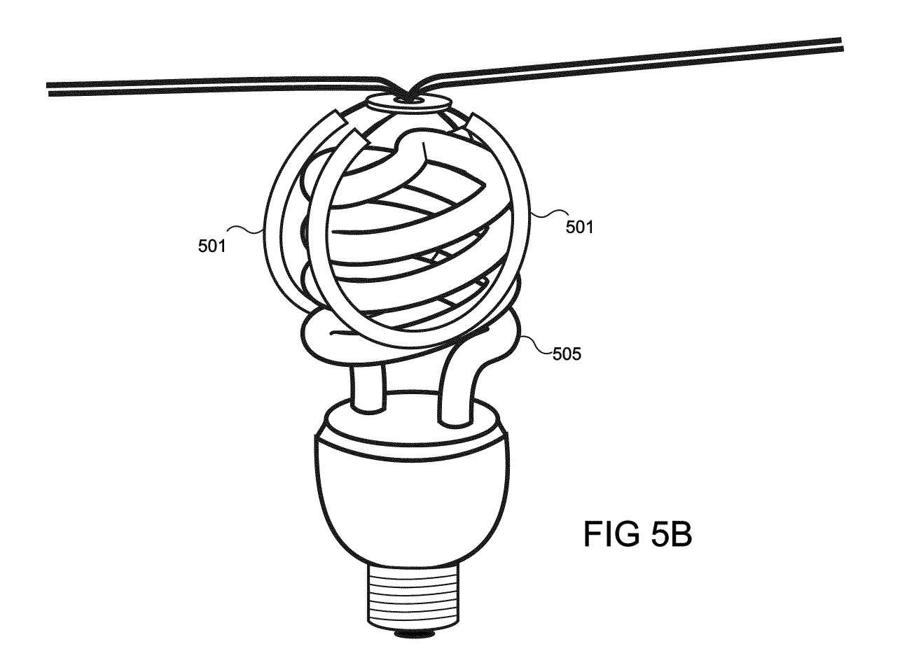

With reference to FIG. 4, the present invention is a retro-fit kit including lengths of elastic tubing 401, 403, where each length of tubing contains a longitudinal cut 405 so as to enable the tubing to mate with and surround the wires 407 of a light-bulb clip, thereby providing increased frictional gripping strength and adequate lampshade support, even when only a fraction of the wire loops of the light-bulb clips make contact with the bulb. In FIG. 4, a length of tubing 401 has been fully installed on one of the wire loops 407 of the light-bulb clip, and a second length of tubing 403 has been almost completely installed on the other of the wire loops 407 of the light-bulb clip. FIG. 5A illustrates attachment of the retro-fit light-bulb clip 501 of FIG. 4 to the standard incandescent light bulb 503 of FIG. 3A, and FIG. 5B illustrates attachment of the retro-fit light-bulb clip 501 of FIG. 4 to the compact, replacement fluorescent light bulb 505 of FIG. 3B.

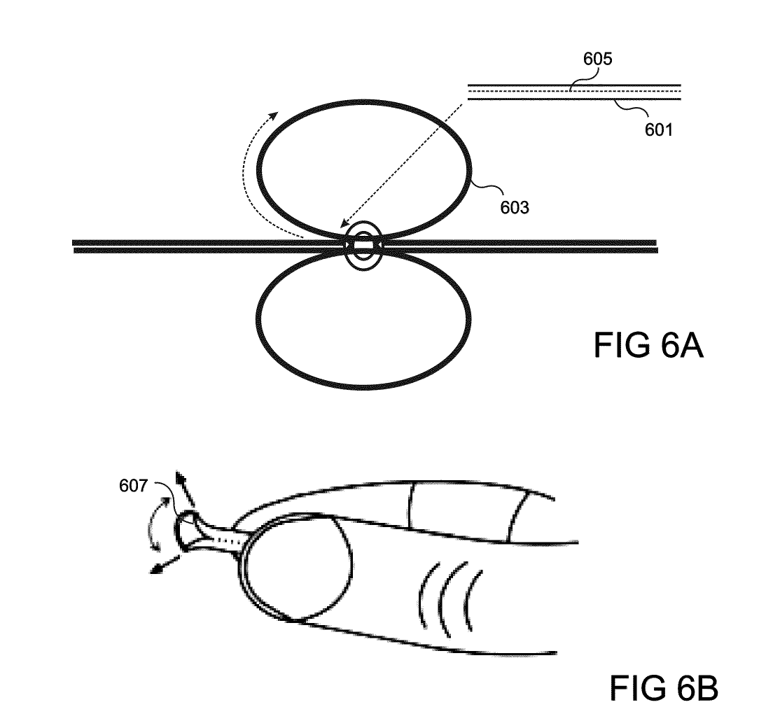

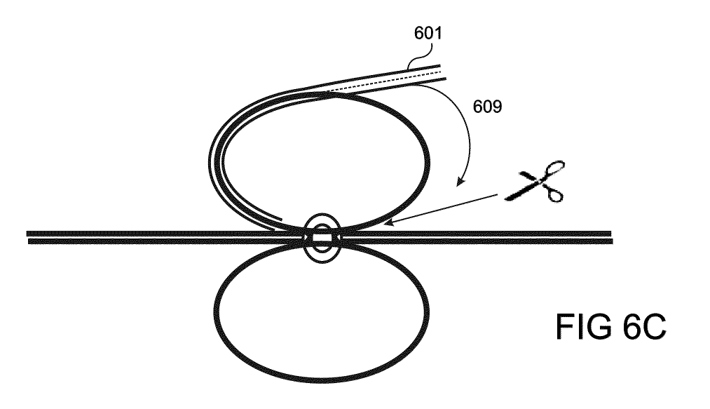

FIG. 6A, FIG. 6B, and FIG. 6C illustrate the method of the present invention. At least one length of elastomeric tubing 601 is provided, as shown in FIG. 6A. The elastomeric tubing has an inner diameter sufficient to surround the wire 603 of the light bulb clip, and its composition is suitable for increasing the frictional gripping strength of the light-bulb clip, while also withstanding heat from direct contact with an operating light bulb. The tubing includes a longitudinal cut 605 extending along its length that allows the tubing to be temporarily pressed open, thereby enabling insertion of the wire and causing the tubing to surround the wire.

FIG. 6B illustrates an end 607 of a length of the tubing being squeezed, thereby causing the tubing to split open at the cut. This creates a gap in the tubing wall, and allows the wire of the light-bulb clip to be pressed into the gap, so that the wire will be surrounded by the tubing when the tubing is released and the gap closes. By applying gentle pressure and some back and forth motion along the length of the wire loop, the tubing can be worked all the around the clip, as illustrated in FIG. 6C, until it has surrounded the wire loop around its entire circumference. The tubing will then stay firmly in place, unless and until it is pried up on one end and peeled off of the wire loop. This removable feature allows the tubing to be reused repeatedly, if the need to replace the clip-on lampshade should arise, for example.

To complete the retro-fit, the process of applying the tubing is repeated on the other wire loop of the light-bulb clip. For a typical clip-on lampshade, each lampshade requires two pieces of split silicone tubing, each piece of tubing being approximately 6 inches in length. The different pieces of tubing can be cut from a single length of split tubing. The thickness and/or the inner diameter of the split tubing can be varied according to the specific requirements of a given light-bulb clip.

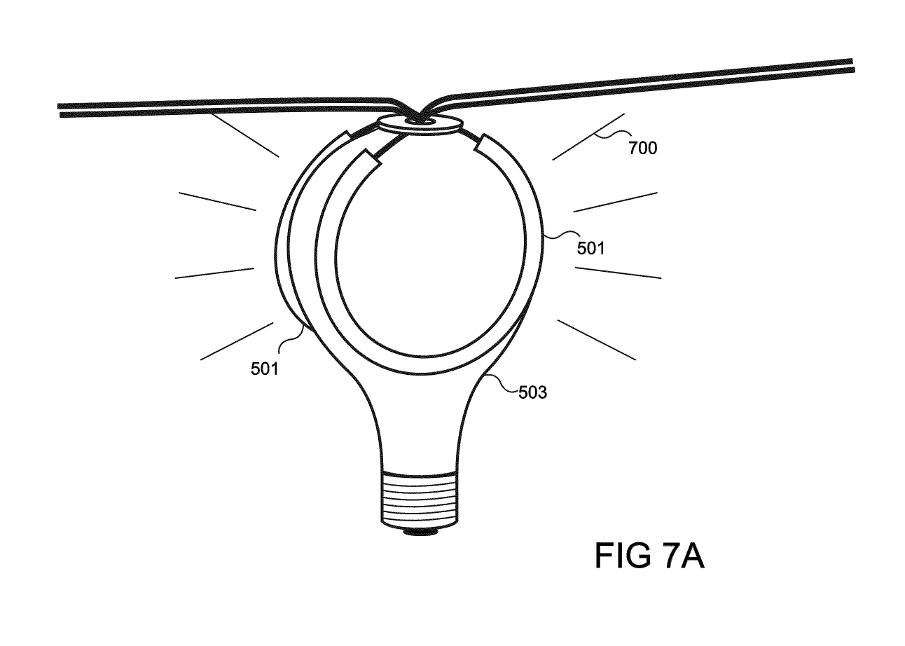

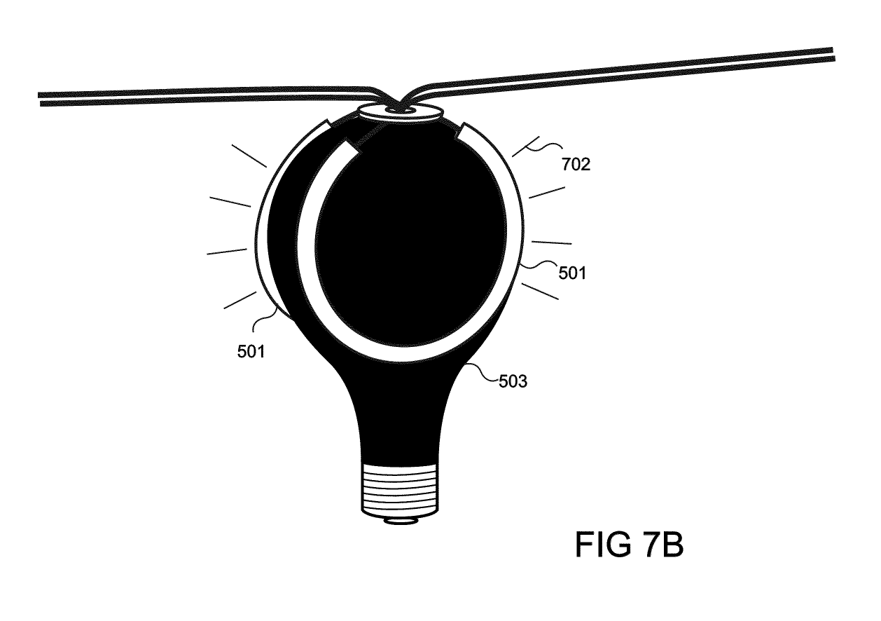

In some preferred embodiments of the present invention, the elastomeric tubing 501 includes a phosphorescent ingredient that can absorb light 700 from the light bulb 503 when the light bulb is active, as is shown in FIG. 7A. Even if the light bulb 503 is not active, the phosphorescent ingredient can absorb daylight entering through a window, or any other ambient light that is present. Afterward, when no ambient light is present and if the light bulb is still off, the phosphorescent ingredient will emit a glow of light 702, thereby making it easier for a user to find the lamp in the dark, as shown in FIG. 7B.

Other modifications and implementations will occur to those skilled in the art without departing from the spirit and the scope of the invention as claimed. Accordingly, the above description is not intended to limit the invention except as indicated in the following claims.

What is claimed is:

1. An adaptor kit for increasing a frictional gripping strength of a light-bulb clip, the light-bulb clip being made of shaped lengths of wire that frictionally grip a light bulb by pressing gripping portions of the shaped lengths of wire against the light bulb, the adaptor kit comprising:
at least one length of elastomeric tubing having a sufficient inner diameter to surround the wire,
the elastomeric tubing having a composition suitable for increasing the frictional gripping strength of the gripping portions, and
the elastomeric tubing including a longitudinal cut extending along its length, the cut allowing the elastomeric tubing to be temporarily split open so as to enable a gripping portion to be inserted therein, and surround the gripping portion with the elastomeric tubing.

2. The adaptor kit of claim 1, wherein the composition of the elastomeric tubing includes at least one of:
PVC;
latex;
silicone;
rubber;
a rubber derivative;
an engineering polymer;
polyalkylene-terephthalate;
isophthalate; and
a copolyester.

3. The adaptor kit of claim 1, wherein the elastomeric tubing is made of heat-resistant silicone.

4. The adaptor kit of claim 1, wherein the elastomeric tubing is adapted to withstand heat from sustained direct contact with an operating incandescent light bulb having a rating of at least 150 Watts.

5. The adaptor kit of claim 1, wherein the adaptor kit comprises two lengths of elastomeric tubing.

6. The adaptor kit of claim 5, wherein each of the lengths of elastomeric tubing has a length of substantially six inches.

7. The adaptor kit of claim 1, wherein the elastomeric tubing can be cut to a desired length for installation on a light-bulb clip.

8. The adaptor kit of claim 1, wherein the elastomeric tubing includes a phosphorescent ingredient that can absorb ambient light and then emit a glow of light when no ambient light is present.

9. A method for converting a standard light-bulb clip to a light-bulb clip with enhanced gripping capabilities, the light-bulb clip being formed of shaped lengths of wire that frictionally grip a light bulb by pressing gripping portions of the shaped lengths of wire against the light bulb, the method comprising:
providing a piece of elastomeric tubing having a sufficient inner diameter to surround the wire, the elastomeric tubing having a composition suitable for increasing the frictional gripping strength of the gripping portions, the elastomeric tubing including a longitudinal cut extending along its length, the cut allowing the elastomeric tubing to be temporarily split open so as to insert a gripping portion therein and surround the gripping portion with the elastomeric tubing;
temporarily splitting open a section of the elastomeric tubing;
inserting a segment of a gripping portion into the open section of elastomeric tubing;
releasing the section of elastomeric tubing, thereby causing the section of elastomeric tubing to surround the segment of the gripping portion;
repeating the splitting, inserting, and releasing until substantially all of the gripping portion is surrounded by the elastomeric tubing;
cutting the elastomeric tubing so as to remove excess elastomeric tubing length, if any excess elastomeric tubing exists; and
repeating all above steps until all of the gripping portions are surrounded by lengths of elastomeric tubing.

10. The method of claim 9, wherein the composition of the elastomeric tubing includes at least one of:
PVC;
latex;
silicone;
rubber;
a rubber derivative;
an engineering polymer;
polyalkylene-terephthalate;
isophthalate; and
a copolyester.

11. The method of claim 9, wherein the elastomeric tubing is made of heat-resistant silicone.

12. The method of claim 9, wherein the elastomeric tubing is adapted to withstand heat from sustained direct contact with an operating incandescent light bulb having a rating of at least 150 Watts.

13. The method of claim 9, wherein two lengths of elastomeric tubing are provided.

14. The method of claim 13, wherein each of the lengths of elastomeric tubing has a length of substantially six inches.

15. The method of claim 9, wherein the elastomeric tubing can be cut into desired lengths for installation on a light-bulb clip.

16. The method of claim 9, wherein the elastomeric tubing includes a phosphorescent ingredient that can absorb ambient light, and then emit a glow of light when no ambient light is present.
